(19) United States
(12) Patent Application Publication
(10) Pub. No.: US 2009/0328029 A1
(43) Pub. Date: Dec. 31, 2009

(54) SOFTWARE PORTAL SYSTEM FOR PROVIDING RELATION INFORMATION OF SOFTWARE AND DATA FORMAT AND METHOD OF OPERATING THE SAME

(76) Inventors: Sung Joo Kang, Seoul (KR); Kyong I. Ku, Gyeonggi-do (KR); Wan Choi, Daejeon (KR); Moon Young Chung, Daejeon (KR); Myung Joon Kim, Daejeon (KR)

Correspondence Address: STAAS & HALSEY LLP, SUITE 700, 1201 NEW YORK AVENUE, N.W., WASHINGTON, DC, 20005, US

(21) Appl. No.: 12/517,706

(22) PCT Filed: Dec. 4, 2007
(86) PCT No.: PCT/KR2007/006235

§ 371 Date: Jun. 4, 2009

(30) Foreign Application Priority Data
Dec. 4, 2006 (KR) 10-2006-0121315
Aug. 7, 2007 (KR) 10-2007-0079022

(51) Int. Cl. G06F 9/44

(52) U.S. Cl. 717/173

(57) ABSTRACT

A software portal system for providing relation information of software and a data format, and a method of operating the same are provided. To provide software by downloading or service simultaneously with relation information between software and software, software and a data format, and data formats, the software portal system includes a relation information management unit and a web service providing unit. The relation information system defines a relation of software and a data format to constitute and manage relation information of the software and the data format. The web service providing unit acquires and provides the relation information of the software managed by the relation information management unit when the software is provided by downloading or service, and acquires and provides the relation information of the data format managed by the relation information management unit when the relation information of the data format is inquired. Accordingly, a user can be provided with high quality of service.

### TECHNICAL FIELD

The present disclosure relates to a software portal system and a method of operating the same, and particularly, to a software portal system, which is configured to provide information of every software or data format related to specific software or a specific data format, and a method of operating the same.

This work was supported by the IT R&D program of MIC/IITA [2005-S-007-02, A Development of Open Software Based On-Demand Officeware Deployment Technologies].

### BACKGROUND ART

The software used to be provided through a software compact disk (CD) offered by a software developer, but now is being provided via the Internet.

In general, to provide software via the Internet, a download method or a service method may be used.

In the download method, an installation file of the software is downloaded to a user terminal to install the corresponding software on the user terminal.

In the service method, software is used directly on the Internet without being installed on a user terminal. Such software includes Internal portal system service or software streaming such as a motion picture service program, and a map search program.

The software may operate independently or only by interworking with another software such as a component and a codec, or may be made by inheritance from another software.

Thus, the software may have an operational relation with another software, such as a share relation, a requirement relation, and an inheritance relation.

The software generates a file having a data format recognizable by corresponding software as an operation result. The data format may be recognized by a variety of software or only by specific software. Examples of the data format recognizable by a variety of software may include a Joint Photographic Experts Group (JPEG) image file (jpg), a Moving Picture Experts Group (MPEG) file (mpg), and a text file (txt). Examples of the data format recognizable only by the specific software may include a Microsoft word file (doc), a power point file (ppt), and a Hangul file (hwp).

According to operational characteristics, the software may recognize only its own data format, or a data format of another software. Also, the software may modify a data format recognizable only by specific software into a generalized data format recognizable by a variety of software (e.g., modifies “wmv” a window media player dedicated file into “mpg”). The software may also combine two different data formats (e.g., combination of a moving image and subtitle data).

Accordingly, it can be seen that various operational relations exist between data formats and between software and a data format, as well as between software and software.

### DISCLOSURE OF INVENTION

### Technical Problem

Predetermined operational relations exist between software and software, between data formats, and between software and a data format. These relations greatly affect software execution, and execution of a file having a data format.

Even though the relation information can increase efficiency of file execution, a system and method for comprehensively providing this information have not been provided in the conventional art.

### Technical Solution

According to an aspect of the present invention, there is provided a software portal system including: a relation information management unit configured to define a relation of software and a data format with another software and data format to constitute and manage relation information of the software and the data format; and a web service providing unit configured to acquire and provide the relation information of the software when the software is provided by downloading or service, and to acquire and provide the relation information of the data format unit when the relation information of the data format is inquired, wherein the relation information of the software and the data format is managed by the relation information management unit.

The relation information of the software may include: information of software having at least one relation with the software among a share relation, a requirement relation, a inheritance relation, a conversion relation, a combination relation, and a user definition information; and information of a data format having at least one relation of a recognition relation and a user definition relation with the software. The relation information of the data format may include information of software having at least one relation of a recognition relation and a user definition relation with the data format.

The web service providing unit may be configured to download the software and the relation information of the software when the software is downloaded, to provide the relation information of the software and access information of a server providing the software by service when the software is in service, and to acquire and provide the relation information of the data format when the relation information of the data format is inquired.

According to another aspect of the present invention, there is provided a method of operating a software portal system, including: defining a relation of software and a data format with another software and data format to constitute and manage relation information of the software and the data format; acquiring software to be downloaded and relation information of the software, and downloading the software and the relation information when software downloading is requested; acquiring and providing relation information of software to be provided by service, and then acquiring the software and providing the software by service when software service is requested; and acquiring and providing the relation information of the data format when the relation information of the software is inquired.

The relation information of the software may include: information of software having at least one relation with the software among a share relation, a requirement relation, a inheritance relation, a conversion relation, a combination relation, and a user definition information; and information of a data format having at least one relation of a recognition relation and a user definition relation with the software. The relation information of the data format may include information of software having at least one relation of a recognition relation and a user definition relation with the data format.

The providing of the software by service may include: acquiring and providing the relation information of the software and access information of a server that is to provide software service, when the software service is requested; and acquiring the software and providing the software by service when access using the access information is detected.

The constituting of the relation information of the software and the data format may include: selecting software or a data format to set a relation; inquiring every software or data format related to the selected software or data format; defining a relation of the selected software or data format with the inquired software or data format; and generating or upgrading the relation information on the basis of the defined relation.

The details of one or more embodiments are set forth in the accompanying drawings and the description below. Other features will be apparent from the description and drawings, and from the claims.

### Advantageous Effects

An aspect of the present invention provides a software portal system for providing relation information of software and a data format, and a method of operating the same, which is configured to manage relations between software and software, between software and a data format, and between data formats, and to provide information of these relations together with the software when the software is provided by a download method or a service method, so that a user can be provided with a high-quality service.

### BRIEF DESCRIPTION OF THE DRAWINGS

FIG. 1 is a block diagram of a software portal system according to an embodiment of the present invention.

FIG. 2 shows relations between software and software, between software and a data format, and between data formats, which are managed by a relation information management unit according to an embodiment of the present invention.

FIG. 3 is a flowchart for explaining a method of operating a software portal system according to an embodiment of the present invention.

FIG. 4 is a flowchart for explaining a method for setting a relation between software and software according to an embodiment of the present invention.

### BEST MODE FOR CARRYING OUT THE INVENTION

Exemplary embodiments of the present invention that would be easily embodied by those of ordinary skill in the art will now be described in detail with reference to the accompanying drawings. However, in detailed description of operational principle according to the exemplary embodiments, well-known functions, well-known structures will not be described in detail to avoid ambiguous interpretation of the present invention.

Also, like reference numerals are used for like elements throughout the specification.

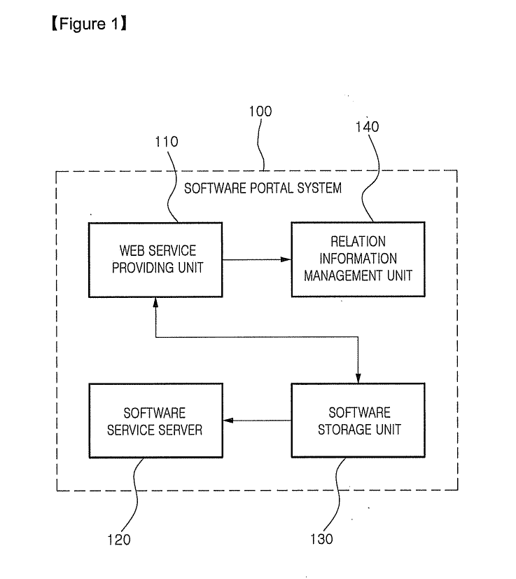

FIG. 1 is a block diagram of a software portal system according to an embodiment of the present invention.

Referring to FIG. 1, the software portal system 100 includes a web service providing unit 100, a software service server 120, a software storage unit 130, and a relation information management unit 140.

Functions of those respective elements will now be described.

The web service providing unit 100 provides a web page to allow access of a user. Also, the web service providing unit 110 performs an operation requested by a user, controlling the relation information management unit 140 to acquire relation information corresponding to the requested operation.

When the user accesses the software service server 120 and requests the software service server to provide service in a specific method of specific software, the software service server 120 searches the software storage unit 130 to acquire the requested software, and provides the software in the requested method by service.

The software storage unit 130 stores at least one software program that the software portal system 100 provides by downloading or service.

The relation information management unit 140 defines relations between software and software, between software and a data format, and between data formats, and constitutes and manages relation information of the software, and relation information of the data format.

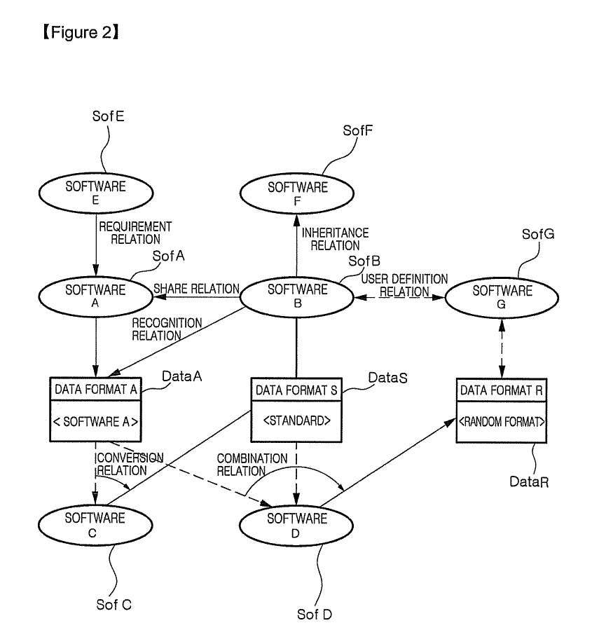

FIG. 2 shows relations between software and software, between software and a data format, and between data formats, which are managed by a relation information management unit according to an embodiment of the present invention.

Data format A DataA is a data format generated through software A SofA, and data format S DataS is a standard data format.

The software A SofA is in a recognition relation with the data format A DataA, which is a data format dedicated to the software A SofA.

Since software B SofB can recognize the data format A DataA, the software B SofB is also in a recognition relation with the data format A. The software B SofB recognizes the same data format as the software A SofA, and thus is in a share relation with the software A SofA.

Software C SofC can convert the data format A DataA into the data format S DataS, and thus is in a conversion relation. Software D SofD combines the data format A DataA with the data format S DataS to generate data format R DataR, which is a new data format, and thus is in a combination relation.

Software E SofE is required to execute the software A SofA, and thus is in a requirement relation. Software F SofF is formed on the basis of the software B SofB, and is thus in an inheritance relation.

Software G SofG is random software, and is in a user definition relation with the data format R DataR and the software B SofB. The user definition relation is a relation with software or a data format defined randomly by a user or a developer.

The relation information of the software includes information about software having at least one relation with the corresponding software among the share relation, the requirement relation, the inheritance relation, the conversion relation, the combination relation, and the user definition relation, and information about a data format having at least one relation of the recognition relation and the user definition relation with the corresponding software.

The relation information of the data format includes information about software having at least one relation of the recognition relation and the user definition relation with the corresponding data format.

The software portal system 100 according to the present invention constitutes the relation information according to the defined relations, so that the system 100 can provide relation information corresponding to software or a data format required by a user.

For example, when the user requests software that can recognize a file having the data format A DataA, the software portal system 100 provides the user with information of the software A SofA and the software B SofB in the recognition relation with the data format A, information of the software C SofC in the conversion relation, and information of the software D SofD in the combination relation.

Accordingly, the user can accurately recognize software for executing the file having the data format A DataA, and perform the next operation.

That is, if corresponding software programs are installed on a user's computer, the user can select one of the software programs to execute the file. If not, the user can request the software portal system 100 to provide software for the file execution in a download or service method.

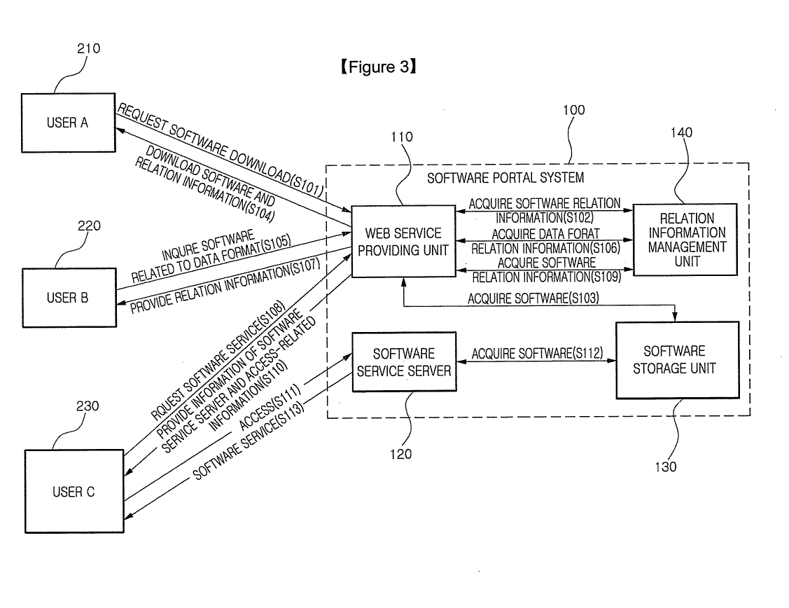

FIG. 3 is a flowchart for explaining a method of operating a software portal system according to an embodiment of the present invention.

In FIG. 3, the software portal system 100 can provide software by downloading or service.

First, when user A 210 accesses a web page of the software portal system 100 to inquire specific software, and then requests downloading of the software in operation S101, the web service providing unit 110 determines every software and data format to the corresponding software, and their relations through the relation information management unit 140. That is, the web service providing unit 100 acquires relation information of the corresponding software in operation S102, acquires the corresponding software stored in the software storage unit 130 in operation S103, and downloads its relation information as well as the corresponding software in operation S104.

When user B 220 accesses a web page of the software portal system 100 to inquire software related to a specific data format in operation S105, the web service providing unit 110 detects every software that can recognize the corresponding data format through the relation information management unit 140. That is, the web service providing unit 110 acquires relation information of the corresponding data format in operation S106, and provides the user B 220 with the acquired relation information in operation S107, so that the user B 220 can easily recognize and select software to execute a file having the corresponding data format.

When user C 230 inquires specific software, and requests software service in operation S108, the web service providing unit 110 determines every software and data format related to the corresponding software, and their relations with the corresponding software through the relation information management unit 140. That is, the web service providing unit 110 acquires relation information of the corresponding software in operation S109, and simultaneously acquires access information of the software service server 120. Then, the web service providing unit 110 provides the user C 230 with the relation information of the software and the access information in operation S110.

Then, the user C 230 accesses a software service server 120 in the software portal system 100 by using the received access information in operation S111. In response thereto, the software service server 120 acquires the corresponding software from the software storage unit 130 in operation S112, and provides the software by service to the user C 230 in operation S113.

If the software service requested in operation S108 cannot be normally provided to the user C 230 or to the software portal system 100 because of various operational environments, the user C 230 can be provided with software related with the corresponding software as an alternative so that an alternative operation can be performed. That is, the user C 230 can perform stable operations according to the present invention.

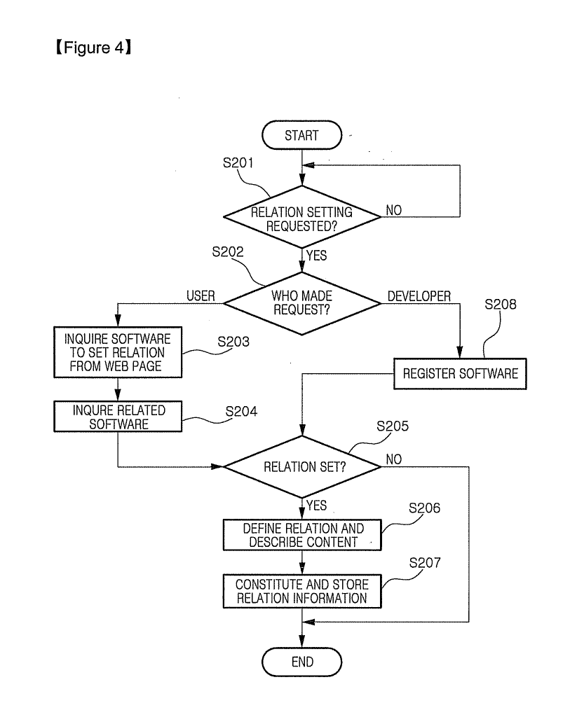

FIG. 4 is a flowchart for explaining a method for setting a relation between software and software according to an embodiment of the present invention.

In FIG. 4, description will be made on the assumption that a software developer and a user can set and manage a relation between software and software.

When relation setting between software and software is requested in operation S210, the software portal system 100 determines who has made the request in operation S202.

When a user is the one who made the request, the software portal system 100 provides a web page that allows the user to select software for setting a relation with another software. When the user selects the software to set the relation in operation S203, the software portal system 100 searches software related to the selected software in operation S204.

The software portal system 100 provides a web page to allow the user to set a relation between the selected software and the inquired software. Then, in operation S205 and S206, the user defines the relation on the basis of, for example, user's use experiences, and describes contents.

In operation S207, the software portal system 100 generates and stores relation information on the basis of the input information.

When the developer is the one who made the request, the relation setting can be performed from the operation S205 after the software is registered to the software portal system 100 in operation S208.

In the above description, only the method for the relation setting between software and software is described. However, it is obvious that relations between software and a data format and between data formats can be set by the same operational principle as in the above description.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A software portal system comprising:
a relation information management unit defining a relationship between softwares and/or data formats to constitute and manage relation information of each software and the data format; and
a web service providing unit acquiring and providing the relation information of the software managed by the relation information management unit when the software is provided by downloading or service, and acquiring and providing the relation information of the data format managed by the relation information management unit when the relation information of the data format is inquired.

2. The system of claim 1, wherein the relation information of the software comprises: information of software having at least one relation with the software among a share relation, a requirement relation, a inheritance relation, a conversion relation, a combination relation, and a user definition information; and
information of a data format having at least one relation of a recognition relation and a user definition relation with the software.

3. The system of claim 1, wherein the relation information of the data format comprises information of software having at least one relation of a recognition relation and a user definition relation with the data format.

4. The system of claim 1, wherein the web service providing unit is configured to download the software and the relation information of the software when the software is downloaded, to provide the relation information of the software and access information of a server providing the software by service when the software is in service, and to acquire and provide the relation information of the data format when the relation information of the data format is inquired.

5. The system of claim 4, further comprising a software service server configured to accept user's access using the access information, and to acquire the software and provide the software by service according to a user's request.

6. The system of claim 1, further comprising a software storage unit configured to store at least one software that the software portal system provides by downloading or service.

7. A method of operating a software portal system, the method comprising: defining a relationship between softwares and/or data formats to constitute and manage relation information of each software and the data format;
acquiring software to be downloaded and relation information of the software, and downloading the acquired software and the relation information of the acquired software when software downloading is requested;
acquiring and providing relation information of software to be provided by service, and then acquiring the software and providing the software by service when software service is requested; and
acquiring and providing the relation information of the data format when the relation information of the software is inquired.

8. The method of claim 7, wherein the relation information of the software comprises:
information of software having at least one relation with the software among a share relation, a requirement relation, a inheritance relation, a conversion relation, a combination relation, and a user definition information; and
information of a data format having at least one relation of a recognition relation and a user definition relation with the software.

9. The method of claim 7, wherein the relation information of the data format comprises information of software having at least one relation of a recognition relation and a user definition relation with the data format.

10. The method of claim 7, wherein the providing of the software by service comprises:
acquiring and providing the relation information of the software and access information of a server that is to provide software service, when the software service is requested; and
acquiring the software and providing the software by service when access using the access information is detected.

11. The method of claim 7, wherein the constituting of the relation information of the software and the data format comprises:
selecting software or a data format to set a relation;
inquiring every software and/or data format related to the selected software or data format;
defining a relation of the selected software or data format with the inquired software or data format; and
generating or upgrading the relation information on the basis of the defined relation.
